(19) United States
(12) Patent Application Publication
(10) Pub. No.: US 2025/0047443 A1
(43) Pub. Date: Feb. 6, 2025

(54) MULTI-DCI MULTI-TRP BASED UL TRANSMISSION IN UNIFIED TCI FRAMEWORK

(71) Applicant: Lenovo (Beijing) Limited, Beijing (CN)

(72) Inventors: Bingchao Liu, Beijing (CN); Chenxi Zhu, Fairfax, VA (US); Wei Ling, Beijing (CN); Lingling Xiao, Beijing (CN); Yi Zhang, Beijing (CN)

(73) Assignee: Lenovo (Beijing) Limited, Beijing (CN)

(21) Appl. No.: 18/718,700

(22) PCT Filed: Jan. 5, 2022
(86) PCT No.: PCT/CN2022/070269

§ 371 Date: Jun. 11, 2024

(51) Int. Cl. H04L 5/00; H04W 72/1263

(52) U.S. Cl. CPC H04L 5/0053; H04W 72/1263

(57) ABSTRACT

Methods and apparatuses for multi-DCI multi-TRP based UL transmission in unified TCI framework are disclosed. In one embodiment, a UE comprises a processor; and a receiver coupled to the processor, wherein the processor is configured to receive, via the receiver, an MAC CE including a CORESET pool ID field to activate one or multiple UL or joint TCI states among configured UL or joint TCI states; and receive, via the receiver, a DCI indicating one UL or joint TCI state when multiple UL or joint TCI states are activated.

### FIELD

The subject matter disclosed herein generally relates to wireless communications, and more particularly relates to methods and apparatuses for multi-DCI multi-TRP based UL transmission in unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), Downlink Control Information (DCI), transmission reception point (TRP), Sounding Reference Signal (SRS), Medium Access Control (MAC), MAC control element (MAC CE), Physical Uplink Control Channel (PUCCH), Transmission Configuration Indicator (TCI), Radio Resource Control (RRC), component carrier (CC), control resource set (CORESET), Physical Downlink Control Channel (PDCCH), TS (Technical Specification) (TS refers to 3GPP Technical Specification in this disclosure), Pathloss reference signal (PL-RS), quasi-colocation (QCL), reference signal (RS), Physical Downlink Shared Channel (PDSCH), Demodulation Reference Signal (DM-RS), Channel State Information Reference Signal (CSI-RS), Transmission Configuration Indication (TCI), band width part (BWP), configured grant (CG), Physical Cell Identity (PCID).

Multi-TRP based UL operation was introduced in NR Release 16 by means of multi-DCI based multi-TRP PUSCH transmission. Furthermore, single-DCI based multi-TRP UL transmission was introduced in NR Release 17 to improve robustness of the UL transmission including PUSCH transmission as well as PUCCH transmission.

All multi-TRP based UL transmissions in NR Release 16 and NR Release 17 are based on spatial relation framework under NR Release 15. For example, the TX beam or the spatial relation for PUSCH transmission is determined by the spatial relation info configured for the SRS resource used for the PUSCH transmission; and the TX beam or the spatial setting for PUCCH transmission is directly configured for each PUCCH resource by MAC CE.

In order to reduce the beam indication overhead, unified TCI framework was introduced in NR Release 17 for single-TRP operation. For UL transmission, the TX beam or the UL TX spatial filter or the spatial relation or the spatial setting for all PUSCH and PUCCH transmissions is determined by the single indicated UL TCI state in separate DL/UL TCI framework or the joint TCI state in joint DL/UL TCI framework. Incidentally, each of the UL TX spatial filter, the spatial relation and the spatial setting refers to the same concept as the TX beam.

This disclosure targets supporting the multi-TRP UL transmission with unified TCI framework.

### BRIEF SUMMARY

Methods and apparatuses for multi-DCI multi-TRP based UL transmission are disclosed.

In one embodiment, a UE comprises a processor; and a receiver coupled to the processor, wherein the processor is configured to receive, via the receiver, an MAC CE including a CORESET pool ID field to activate one or multiple UL or joint TCI states among configured UL or joint TCI states; and receive, via the receiver, a DCI indicating one UL or joint TCI state when multiple UL or joint TCI states are activated.

In one embodiment, when one UL or joint TCI state is activated by the MAC CE, the one UL or joint TCI state is associated with the CORESETPoolIndex indicated by CORESET pool ID field included in the MAC CE.

In another embodiment, when multiple UL or joint TCI states are activated by the MAC CE, the activated multiple UL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple UL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

In yet another embodiment, the processor may further be configured to apply the activated or indicated TCI state to PUSCH transmission scheduled by DCI carried by PDCCH received from any CORESET configured with the same CORESETPoolIndex associated with the activated or indicated TCI state; type 2 CG PUSCH transmission activated by DCI carried by PDCCH received from any CORESET configured with the same CORESETPoolIndex associated with the activated or indicated TCI state; type 1 CG PUSCH transmission corresponding to a ConfiguredGrantConfig configured with the same CORESETPoolIndex associated with the activated or indicated TCI state; PUCCH resources scheduled by the DCI format 1_0 or 1_1 or 1_2 carried by PDCCH received from any CORESET configured with the same CORESETPoolIndex associated with the activated or indicated TCI state; aperiodic SRS resources without configured UL or joint TCI state or spatialRelationInfo and triggered by DCI carried by PDCCH received from any CORESET configured with the same CORESETPoolIndex associated with the activated or indicated TCI state; and periodic and semi-persistent SRS resources without configured UL or joint TCI state or spatialRelationInfo and associated with the same CORESETPoolIndex associated with the activated or indicated TCI state, wherein, when only one UL or joint TCI state is activated by the MAC CE, the activated or indicated TCI state is the one activated UL or joint TCI state; and when multiple UL or joint TCI states are activated by the MAC CE, the activated or indicated TCI state is the indicated one UL or joint TCI state by the DCI.

In some embodiment, when the configured UL or joint TCI states are associated with different PCIDs, the RS for TX spatial filter determination in one of the configured UL or joint TCI states and the RS for pathloss calculation associated with the one configured UL or joint TCI state are associated with a same PCID. In some embodiment, all the activated UL or joint TCI states associated with the same CORESETPoolIndex value are associated with a same PCID.

In another embodiment, a method at a UE comprises receiving an MAC CE including a CORESET pool ID field to activate one or multiple UL or joint TCI states among configured UL or joint TCI states; and receiving a DCI indicating one UL or joint TCI state when multiple UL or joint TCI states are activated.

In still another embodiment, a base unit comprises a processor; and a transmitter coupled to the processor, wherein the processor is configured to transmit, via the transmitter, an MAC CE including a CORESET pool ID field to activate one or multiple UL or joint TCI states among configured UL or joint TCI states; and transmit, via the transmitter, a DCI indicating one UL or joint TCI state when multiple UL or joint TCI states are activated.

In yet another embodiment, a method of a base unit comprises transmitting an MAC CE including a CORESET pool ID field to activate one or multiple UL or joint TCI states among configured UL or joint TCI states; and transmitting a DCI indicating one UL or joint TCI state when multiple UL or joint TCI states are activated.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating an embodiment of another method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and all the PDSCHs in a CC. Each CORESET is configured by a set time-frequency resource for PDCCH reception. In this situation, a PL-RS is associated with the indicated UL TCI state for path loss calculation. UL power control parameters other than PL-RS (e.g. set of P0, alpha and closed loop index) for PUSCH, PUCCH and SRS may also be associated with the indicated UL TCI state.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state. In this situation, a PL-RS is associated with the indicated joint DL/UL TCI state for path loss calculation. UL power control parameters other than PL-RS (e.g. set of P0, alpha and closed loop index) for PUSCH, PUCCH and SRS may also be associated with the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |
| ... | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| } | |

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ in one DL BWP of a serving cell. When a UE supports two TCI states in a codepoint of the DCI field ‘Transmission Configuration Indication’ the UE may receive an activation command, the activation command is used to map up to 8 combinations of one or two TCI states to the codepoints of the DCI field ‘Transmission Configuration Indication’.

A first embodiment relates to multi-DCI based multi-TRP UL transmission in intra-cell multi-TRP operation.

In multi-DCI based multi-TRP UL transmission, each CORESET is configured with a higher layer parameter CORESETPoolIndex for TRP differentiation. For example, multiple TRPs (e.g. two TRPs) can be configured for a BWP of a cell for a UE. All the CORESET(s) configured for one TRP may be configured with CORESETPoolIndex=0 and all the CORESET(s) configured for the other TRP may be configured with CORESETPoolIndex=1. Specifically, when CORESETPoolIndex is configured for at least one CORESET of the active BWP, a CORESET Pool ID field shall be contained in the UL TCI states activation/deactivation MAC CE or the joint TCI state activation/deactivation MAC CE.

An MAC CE (e.g. UL TCI states activation/deactivation MAC CE or the joint TCI state activation/deactivation MAC CE) activates one or multiple configured UL TCI states (when separate DL/UL TCI is configured) or one or multiple configured joint TCI states (when joint DL/UL TCI is configured).

All the activated UL TCI states or all of activated joint TCI states are associated with a CORESETPoolIndex indicated by the CORESET Pool ID field included in the MAC CE. In the following description, UL TCI state(s) or joint TCI state(s) is abbreviated as UL or joint TCI state(s).

If only one UL or joint TCI state is activated, the activated UL or joint TCI state is associated with the CORESETPoolIndex indicated by the CORESET Pool ID field contained in the MAC CE.

If multiple (e.g. two or more) UL or joint TCI states are activated by the MAC CE, the CORESET Pool ID field indicates the mapping between the activated UL or joint TCI states and the codepoints of the Transmission Configuration Indication (TCI) field contained in DCI format 1_1 or 1_2 carried in PDCCH received from any CORESET(s) configured with a CORESETPoolIndex with the same value as indicated by the CORESET Pool ID field of the MAC CE. The CORESET Pool ID field set to 1 indicates that the activated UL or joint TCI state(s) are mapped to the TCI codepoints indicated by DCI format 1_1 or 1_2 carried by PDCCH received from CORESET(s) configured with CORESETPoolIndex=1, and CORESET Pool ID field set to 0 indicates that the activated UL or joint TCI states are mapped to the TCI codepoints indicated by DCI format 1_1 or 1_2 carried by PDCCH received from CORESET(s) configured with CORESETPoolIndex=0.

If multiple UL or joint TCI states are activated by the MAC CE, one of the activated UL or joint TCI states is further indicated by DCI format 1_1 or 1_2. In particular, one of the activated UL or joint TCI states activated by the MAC CE containing a CORESET Pool ID field is further indicated by DCI format 1_1 or 1_2 carried by PDCCH received from any CORESET configured with CORESETPoolIndex having the same value as that indicated by the CORESET Pool ID field. In this situation, the indicated UL or joint TCI state is associated with the CORESETPoolIndex that is configured for the CORESET transmitting the PDCCH carrying the DCI format 1_1 or 1_2, which is the same value as that indicated by the CORESET Pool ID field included in the MAC CE.

The indicated UL or joint TCI state (when multiple UL or joint TCI states are activated by the MAC CE, and one of the multiple activated UL or joint TCI states is indicated by DCI format 1_1 or 1_2) or the only one activated UL or joint TCI state (when one UL or joint TCI state is activated by the MAC CE) can be collectively abbreviated as “the activated or indicated TCI state” in the following description. The activated or indicated TCI state applies to PUSCH transmission, PUCCH transmission and SRS transmission as follows:

For PUSCH transmission (e.g. PUSCH transmission scheduled by DCI, type 2 CG PUSCH transmission activated by the DCI, and type 1 CG PUSCH transmission triggered by RRC signaling), the activated or indicated TCI state applies to:
PUSCH transmission scheduled by DCI carried by PDCCH received from any CORESET configured with the same CORESETPoolIndex associated with the activated or indicated TCI state;
type 2 CG PUSCH transmission activated by DCI carried by PDCCH received from any CORESET configured with the same CORESETPoolIndex associated with the activated or indicated TCI state; and
type 1 CG PUSCH transmission configured by an RRC signaling configuredGrantConfig configured with the same CORESETPoolIndex associated with the activated or indicated TCI state.

In the situation of the type 1 CG PUSCH transmission, a higher layer parameter CORESETPoolIndex is expected to be configured for a CG-PUSCH configuration configured by RRC signaling configuredGrantConfig IE. If CORESETPoolIndex is not configured for a CG-PUSCH configuration, CORESETPoolIndex=0 is assumed.

Incidentally, a brief summary of CG PUSCH is as follows. CG (configured grant) PUSCH is used for semi-static UL traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig IE) and each configuredGrantConfig has an ID.

For PUCCH transmission, the activated or indicated TCI state applies to PUCCH resources scheduled by DCI format 1_0 or 1_1 or 1_2 carried by PDCCH received from any CORESET configured with the same CORESETPoolIndex associated with the activated or indicated TCI state. The PUCCH resource is indicated by the PUCCH resource indicator field contained in the DCI with format 1_0 or 1_1 or 1_2.

For SRS transmission (e.g. aperiodic SRS resources, semi-persistent SRS resources, and periodic SRS resources), the activated or indicated TCI state applies to:
the aperiodic SRS resources without configured UL or joint TCI state or spatial Relation and triggered by DCI carried by PDCCH received from any CORESET configured with the same CORESETPoolIndex associated with the activated or indicated TCI state; and
semi-persistent SRS resources and periodic SRS resources without configured UL or joint TCI state or spatial Relation and associated with the same CORESETPoolIndex associated with the activated or indicated TCI state.

The semi-persistent SRS resource associated with the same CORESETPoolIndex associated with the activated or indicated TCI state refers to the semi-persistent SRS resource activated by MAC CE carried by PDSCH scheduled by DCI carried in PDCCH received from any CORESET configured with the same CORESETPoolIndex associated with the activated or indicated TCI state.

An example of the first embodiment is described as follows:

A UE is configured with separate DL/UL TCI framework. 64 UL TCI states (e.g., UL TCI-State #0, UL TCI-State #1 . . . , UL TCI-State #63) are configured for the active BWP. CORESETPoolIndex with value 0 (i.e. CORESETPoolIndex=0) is configured for CORESET #1, CORESET #2 and CORESET #3 in current active BWP, and CORESETPoolIndex with value 1 (CORESETPoolIndex=1) is configured for CORESET #4 and CORESET #5.

The UE receives an MAC CE (e.g. UL TCI states activation/deactivation MAC CE) including a CORESET pool ID field equal to 0 that activates UL TCI-State #2 for TCI codepoint 001, UL TCI-State #12 for TCI codepoint 010, UL TCI-State #14 for TCI codepoint 011, and UL TCI-State #23 for TCI codepoint 101. The UE also receives another MAC CE (e.g. UL TCI states activation/deactivation MAC CE) including a CORESET pool ID field equal to 1 that activates TCI-State #32 for TCI codepoint 001, UL TCI-State #42 for TCI codepoint 010, UL TCI-State #54 for TCI codepoint 011, UL TCI-State #63 for TCI codepoint 101.

If the UE receives a DCI format 1_1 with TCI field value 010 from CORESET #2 (having CORESETPoolIndex=0), the TCI field value 010 indicates UL TCI-State #12 as the UL TCI state. According to the first embodiment, the indicated UL TCI state (i.e. UL TCI-State #12) (associated with CORESETPoolIndex=0) shall be applied to:
PUSCH transmission scheduled by DCI carried by PDCCH transmitted from any of CORESET #1, CORESET #2, and CORESET #3;
type 2 CG PUSCH transmission activated by DCI carried by PDCCH transmitted from any of CORESET #1, CORESET #2, and CORESET #3;
type 1 CG PUSCH transmission configured with CORESETPoolIndex=0;
PUCCH transmission scheduled by DCI carried by PDCCH transmitted from any of CORESET #1, CORESET #2, and CORESET #3;
aperiodic SRS transmission triggered by DCI from any of CORESET #1, CORESET #2, and CORESET #3;
semi-persistent SRS transmission configured with CORESETPoolIndex=0, e.g. semi-persistent SRS transmission activated by MAC CE carried by PDSCH scheduled by DCI carried by PDCCH received from any of CORESET #1, CORESET #2, and CORESET #3; and
periodic SRS resource transmission configured with CORESETPoolIndex=0.

If the UE receives a DCI format 1_1 with TCI field value 010 from CORESET #5 (having CORESETPoolIndex=1), the TCI field value 010 indicates UL TCI-State #42 as the UL TCI state. According to the first embodiment, the indicated UL TCI state (i.e. UL TCI-State #42) (associated with CORESETPoolIndex=1) shall be applied to:
PUSCH transmission scheduled by DCI carried by PDCCH transmitted from any of CORESET #4 and CORESET #5;
type 2 CG PUSCH transmission activated by DCI carried by PDCCH transmitted from any of CORESET #4 and CORESET #5;
Type 1 CG PUSCH transmission configured with CORESETPoolIndex=1;
PUCCH transmission scheduled by DCI carried by PDCCH transmitted from any of CORESET #4 and CORESET #5;
aperiodic SRS transmission triggered by DCI from any of CORESET #4 and CORESET #5;
semi-persistent SRS transmission associated with CORESETPoolIndex=1, e.g. semi-persistent SRS transmission activated by MAC CE carried by PDSCH scheduled by DCI carried by PDCCH received from any of CORESET #4 and CORESET #5; and
periodic SRS resource transmission corresponding to the SRS resources from the SRS resource set configured with CORESETPoolIndex=1.

As a whole, according to the first embodiment, when unified TCI framework is configured, each activated TCI state is associated with a CORESETPoolIndex. When each TCI state is associated with a CORESETPoolIndex, the indicated TCI state only applies to the PUSCH transmission or PUCCH transmission or SRS transmission associated with the same CORESETPoolIndex.

A second embodiment relates to multi-DCI based multi-TRP UL transmission in inter-cell multi-TRP operation.

Inter-cell beam management was supported in NR Release 17, where SSB associated with a PCID different from the PCID associated with the serving cell can be configured in TCI state for DL beam indication as well as UL beam indication. A PL-RS (for pathloss calculation) is associated with an indicated or activated UL or joint TCI state to calculate the DL channel pathloss for UL Tx power calculation. When a UL signal (e.g. PUSCH transmission, PUCCH transmission, SRS transmission) is transmitted to a TRP associated with a PCID, the RS for TX beam determination configured in the indicated or activated UL or joint TCI state and the PL-RS associated with the indicated or activated UL or joint TCI state should be associated with a same PCID. In addition, the same PCID associated with the RS for TX beam determination and with the PL-RS is the same as the PCID associated with the TRP to which the UL signal is transmitted.

Specifically, for UL TCI state in separate DL/UL TCI framework, the RS configured in UL TCI state for UL TX spatial filter determination and the PL-RS should be associated with the same PCID. For joint TCI state in joint DL/UL TCI state framework, the RS configured in joint TCI state with QCL-TypeD and the PL-RS should be associated with the same PCID.

Additionally, to simplify UE implementation on UL signal collision handling, when different TCI states are associated with different PCID values, all the activated UL or joint TCI states associated with the same CORESETPoolIndex should be associated with a same PCID.

An example of the second embodiment is described as follows:

A UE is configured with joint DL/UL TCI framework. 64 joint TCI states (e.g., joint TCI-State #0, joint TCI-State #1, . . . , joint TCI-State #63) are configured for the active BWP. In this situation, the UL TX spatial filter is determined by the QCL-TypeD RS configured in each joint TCI state.

Joint TCI-State #0, joint TCI-State #1, . . . , joint TCI-State #31 are associated with the serving cell (e.g., physical cell with PCID #0).

Joint TCI-State #32, joint TCI-State #33, . . . , joint TCI-State #47 are associated with a non-serving cell (e.g., physical cell with PCID #1).

Joint TCI-State #48, joint TCI-State #49, . . . , joint TCI-State #63 are associated with another non-serving cell (e.g., physical cell with PCID #2).

The QCL-TypeD RS configured in each of joint TCI-State #0, joint TCI-State #1, . . . , joint TCI-State #31 and the PL-RS associated with the corresponding joint TCI state (i.e. each of joint TCI-State #0, joint TCI-State #1, . . . , joint TCI-State #31) should be associated with PCID #0.

The QCL-TypeD RS configured in each of joint TCI-State #32, joint TCI-State #33, . . . , joint TCI-State #47 and the PL-RS associated with the corresponding joint TCI state (i.e. each of joint TCI-State #32, joint TCI-State #33, . . . , joint TCI-State #47) should be associated with PCID #1.

The QCL-TypeD RS configured in each of joint TCI-State #48, joint TCI-State #49, . . . , joint TCI-State #63 and the PL-RS associated with the corresponding joint TCI state (i.e. each of joint TCI-State #48, joint TCI-State #49, . . . , joint TCI-State #63) should be associated with PCID #2.

When the gNB wants to configure inter-cell multi-TRP operation, if a subset of joint TCI-State #0, joint TCI-State #1, . . . , joint TCI-State #31 are activated for CORESETPoolIndex=0, the gNB can only activate a subset of joint TCI-State #32, joint TCI-State #33, . . . , joint TCI-State #47 or a subset of joint TCI-State #48, joint TCI-State #49, . . . , joint TCI-State #63 for CORESETPoolIndex=1.

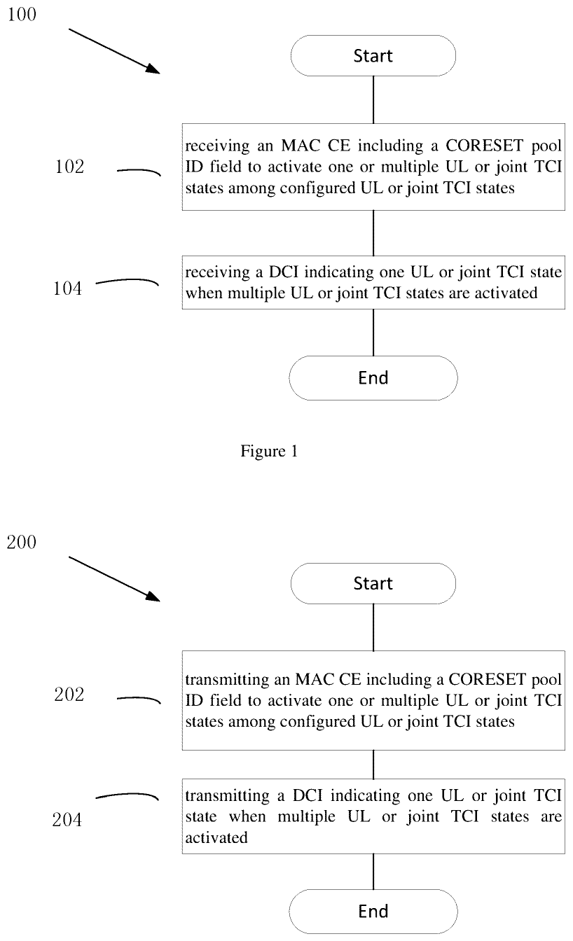

FIG. 1 is a schematic flow chart diagram illustrating an embodiment of a method 100 according to the present application. In some embodiments, the method 100 is performed by an apparatus, such as a remote unit (e.g. UE). In certain embodiments, the method 100 may be performed by a processor executing program code, for example, a microcontroller, a microprocessor, a CPU, a GPU, an auxiliary processing unit, a FPGA, or the like.

The method 100 is a method of a UE, comprising: 102 receiving an MAC CE including a CORESET pool ID field to activate one or multiple UL or joint TCI states among configured UL or joint TCI states; and 104 receiving a DCI indicating one UL or joint TCI state when multiple UL or joint TCI states are activated.

In one embodiment, when one UL or joint TCI state is activated by the MAC CE, the one UL or joint TCI state is associated with the CORESETPoolIndex indicated by CORESET pool ID field included in the MAC CE.

In another embodiment, when multiple UL or joint TCI states are activated by the MAC CE, the activated multiple UL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple UL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

The method may further comprise applying the activated or indicated TCI state to PUSCH transmission scheduled by DCI carried by PDCCH received from any CORESET configured with the same CORESETPoolIndex associated with the activated or indicated TCI state; type 2 CG PUSCH transmission activated by DCI carried by PDCCH received from any CORESET configured with the same CORESETPoolIndex associated with the activated or indicated TCI state; type 1 CG PUSCH transmission corresponding to a ConfiguredGrantConfig configured with the same CORESETPoolIndex associated with the activated or indicated TCI state; PUCCH resources scheduled by the DCI format 1_0 or 1_1 or 1_2 carried by PDCCH received from any CORESET configured with the same CORESETPoolIndex associated with the activated or indicated TCI state; aperiodic SRS resources without configured UL or joint TCI state or spatialRelationInfo and triggered by DCI carried by PDCCH received from any CORESET configured with the same CORESETPoolIndex associated with the activated or indicated TCI state; and periodic and semi-persistent SRS resources without configured UL or joint TCI state or spatialRelationInfo and associated with the same CORESETPoolIndex associated with the activated or indicated TCI state, wherein, when only one UL or joint TCI state is activated by the MAC CE, the activated or indicated TCI state is the one activated UL or joint TCI state; and when multiple UL or joint TCI states are activated by the MAC CE, the activated or indicated TCI state is the indicated one UL or joint TCI state by the DCI.

In some embodiment, when the configured UL or joint TCI states are associated with different PCIDs, the RS for TX spatial filter determination in one of the configured UL or joint TCI states and the RS for pathloss calculation associated with the one configured UL or joint TCI state are associated with a same PCID.

In some embodiment, all the activated UL or joint TCI states associated with the same CORESETPoolIndex value are associated with a same PCID.

FIG. 2 is a schematic flow chart diagram illustrating an embodiment of a method 200 according to the present application. In some embodiments, the method 200 is performed by an apparatus, such as a base unit. In certain embodiments, the method 200 may be performed by a processor executing program code, for example, a microcontroller, a microprocessor, a CPU, a GPU, an auxiliary processing unit, a FPGA, or the like.

The method 200 may comprise 202 transmitting an MAC CE including a CORESET pool ID field to activate one or multiple UL or joint TCI states among configured UL or joint TCI states; and 204 transmitting a DCI indicating one UL or joint TCI state when multiple UL or joint TCI states are activated.

In one embodiment, when one UL or joint TCI state is activated by the MAC CE, the one UL or joint TCI state is associated with the CORESETPoolIndex indicated by CORESET pool ID field included in the MAC CE.

In another embodiment, when multiple UL or joint TCI states are activated by the MAC CE, the activated multiple UL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple UL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

The method may further comprise determining that the activated or indicated TCI state is applied to PUSCH transmission scheduled by DCI carried by PDCCH received from any CORESET configured with the same CORESETPoolIndex associated with the activated or indicated TCI state; type 2 CG PUSCH transmission activated by DCI carried by PDCCH received from any CORESET configured with the same CORESETPoolIndex associated with the activated or indicated TCI state; type 1 CG PUSCH transmission corresponding to a ConfiguredGrantConfig configured with the same CORESETPoolIndex associated with the activated or indicated TCI state; PUCCH resources scheduled by the DCI format 1_0 or 1_1 or 1_2 carried by PDCCH received from any CORESET configured with the same CORESETPoolIndex associated with the activated or indicated TCI state; aperiodic SRS resources without configured UL or joint TCI state or spatialRelationInfo and triggered by DCI carried by PDCCH received from any CORESET configured with the same CORESETPoolIndex associated with the activated or indicated TCI state; and periodic and semi-persistent SRS resources without configured UL or joint TCI state or spatialRelationInfo and associated with the same CORESETPoolIndex associated with the activated or indicated TCI state, wherein, when only one UL or joint TCI state is activated by the MAC CE, the activated or indicated TCI state is the one activated UL or joint TCI state; and when multiple UL or joint TCI states are activated by the MAC CE, the activated or indicated TCI state is the indicated one UL or joint TCI state by the DCI.

In some embodiment, when the configured UL or joint TCI states are associated with different PCIDs, the RS for TX spatial filter determination in one of the configured UL or joint TCI states and the RS for pathloss calculation associated with the one configured UL or joint TCI state are associated with a same PCID.

In some embodiment, all the activated UL or joint TCI states associated with the same CORESETPoolIndex value are associated with a same PCID.

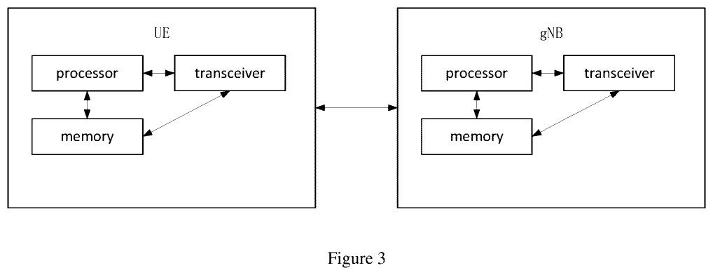

FIG. 3 is a schematic block diagram illustrating apparatuses according to one embodiment.

Referring to FIG. 3, the UE (i.e. the remote unit) includes a processor, a memory, and a transceiver. The processor implements a function, a process, and/or a method which are proposed in FIG. 1.

The UE comprises a processor; and a receiver coupled to the processor, wherein the processor is configured to receive, via the receiver, an MAC CE including a CORESET pool ID field to activate one or multiple UL or joint TCI states among configured UL or joint TCI states; and receive, via the receiver, a DCI indicating one UL or joint TCI state when multiple UL or joint TCI states are activated.

In one embodiment, when one UL or joint TCI state is activated by the MAC CE, the one UL or joint TCI state is associated with the CORESETPoolIndex indicated by CORESET pool ID field included in the MAC CE.

In another embodiment, when multiple UL or joint TCI states are activated by the MAC CE, the activated multiple UL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple UL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

The processor may further be configured to apply the activated or indicated TCI state to PUSCH transmission scheduled by DCI carried by PDCCH received from any CORESET configured with the same CORESETPoolIndex associated with the activated or indicated TCI state; type 2 CG PUSCH transmission activated by DCI carried by PDCCH received from any CORESET configured with the same CORESETPoolIndex associated with the activated or indicated TCI state; type 1 CG PUSCH transmission corresponding to a ConfiguredGrantConfig configured with the same CORESETPoolIndex associated with the activated or indicated TCI state; PUCCH resources scheduled by the DCI format 1_0 or 1_1 or 1_2 carried by PDCCH received from any CORESET configured with the same CORESETPoolIndex associated with the activated or indicated TCI state; aperiodic SRS resources without configured UL or joint TCI state or spatialRelationInfo and triggered by DCI carried by PDCCH received from any CORESET configured with the same CORESETPoolIndex associated with the activated or indicated TCI state; and periodic and semi-persistent SRS resources without configured UL or joint TCI state or spatialRelationInfo and associated with the same CORESETPoolIndex associated with the activated or indicated TCI state, wherein, when only one UL or joint TCI state is activated by the MAC CE, the activated or indicated TCI state is the one activated UL or joint TCI state; and when multiple UL or joint TCI states are activated by the MAC CE, the activated or indicated TCI state is the indicated one UL or joint TCI state by the DCI.

In some embodiment, when the configured UL or joint TCI states are associated with different PCIDs, the RS for TX spatial filter determination in one of the configured UL or joint TCI states and the RS for pathloss calculation associated with the one configured UL or joint TCI state are associated with a same PCID.

In some embodiment, all the activated UL or joint TCI states associated with the same CORESETPoolIndex value are associated with a same PCID.

The gNB (i.e. the base unit) includes a processor, a memory, and a transceiver. The processor implements a function, a process, and/or a method which are proposed in FIG. 2.

The base unit comprises a processor; and a transmitter coupled to the processor, wherein the processor is configured to transmit, via the transmitter, an MAC CE including a CORESET pool ID field to activate one or multiple UL or joint TCI states among configured UL or joint TCI states; and transmit, via the transmitter, a DCI indicating one UL or joint TCI state when multiple UL or joint TCI states are activated.

In one embodiment, when one UL or joint TCI state is activated by the MAC CE, the one UL or joint TCI state is associated with the CORESETPoolIndex indicated by CORESET pool ID field included in the MAC CE.

In another embodiment, when multiple UL or joint TCI states are activated by the MAC CE, the activated multiple UL or joint TCI states are mapped to TCI codepoints indicated by DCI format 1_1 or 1_2 carried by PDCCH received from any CORESET(s) configured with the CORESETPoolIndex value that is the same as that indicated by the CORESET pool ID field included in the MAC CE. In particular, one of the activated multiple UL or joint TCI states is indicated by a DCI format 1_1 or 1_2 carried by PDCCH received from any CORESET configured with CORESETPoolIndex having the same value as that indicated by the CORESET Pool ID field value, and is associated with the same CORESETPoolIndex value configured for the CORESET.

The processor may further be configured to determine that the activated or indicated TCI state is applied to PUSCH transmission scheduled by DCI carried by PDCCH received from any CORESET configured with the same CORESETPoolIndex associated with the activated or indicated TCI state; type 2 CG PUSCH transmission activated by DCI carried by PDCCH received from any CORESET configured with the same CORESETPoolIndex associated with the activated or indicated TCI state; type 1 CG PUSCH transmission corresponding to a ConfiguredGrantConfig configured with the same CORESETPoolIndex associated with the activated or indicated TCI state; PUCCH resources scheduled by the DCI format 1_0 or 1_1 or 1_2 carried by PDCCH received from any CORESET configured with the same CORESETPoolIndex associated with the activated or indicated TCI state; aperiodic SRS resources without configured UL or joint TCI state or spatialRelationInfo and triggered by DCI carried by PDCCH received from any CORESET configured with the same CORESETPoolIndex associated with the activated or indicated TCI state; and periodic and semi-persistent SRS resources without configured UL or joint TCI state or spatialRelationInfo and associated with the same CORESETPoolIndex associated with the activated or indicated TCI state, wherein, when only one UL or joint TCI state is activated by the MAC CE, the activated or indicated TCI state is the one activated UL or joint TCI state; and when multiple UL or joint TCI states are activated by the MAC CE, the activated or indicated TCI state is the indicated one UL or joint TCI state by the DCI.

In some embodiment, when the configured UL or joint TCI states are associated with different PCIDs, the RS for TX spatial filter determination in one of the configured UL or joint TCI states and the RS for pathloss calculation associated with the one configured UL or joint TCI state are associated with a same PCID.

In some embodiment, all the activated UL or joint TCI states associated with the same CORESETPoolIndex value are associated with a same PCID.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a medium access control (MAC) control element (MAC CE) including a control resource set (CORESET) pool ID field to activate one or multiple uplink (UL) or joint transmission configuration indication (TCI) states among configured UL or joint TCI states; and
receive a downlink control information (DCI) indicating one UL or joint TCI state when multiple UL or joint TCI states are activated.

2. The UE of claim 1, wherein when one UL or joint TCI state is activated by the MAC CE, the one UL or joint TCI state is associated with a CORESETPoolIndex indicated by the CORESET pool ID field included in the MAC CE.

3. The UE of claim 1, wherein when multiple UL or joint TCI states are activated by the MAC CE, the activated multiple UL or joint TCI states are mapped to one or more TCI codepoints indicated by DCI format 1_1 or 1_2 carried by physical downlink control channel (PDCCH) received from any one or more CORESETs configured with a CORESETPoolIndex value that is a same value as that indicated by the CORESET pool ID field included in the MAC CE.

4. The UE of claim 3, wherein one of the activated multiple UL or joint TCI states is indicated by the DCI format 1_1 or 1_2 carried by PDCCH received from any CORESET configured with CORESETPoolIndex having a same value as that indicated by the CORESET pool ID field, and is associated with a same CORESETPoolIndex value configured for the CORESET.

5. The UE of claim 1, wherein the at least one processor is further configured to cause the UE to apply the activated or indicated TCI state to one or more of:
physical uplink shared channel (PUSCH) transmission scheduled by DCI carried by physical downlink control channel (PDCCH) received from any CORESET associated with a same CORESETPoolIndex associated with the activated or indicated TCI state;
type 2 configured grant (CG) PUSCH transmission activated by DCI carried by PDCCH received from any CORESET associated with the same CORESETPoolIndex associated with the activated or indicated TCI state; or
type 1 CG PUSCH transmission corresponding to a ConfiguredGrantConfig associated with the same CORESETPoolIndex associated with the activated or indicated TCI state.

6. The UE of claim 1, wherein when the configured UL or joint TCI states are associated with different physical cell identities (PCIDs), a reference signal (RS) for transmitter (TX) spatial filter determination in one of the configured UL or joint TCI states and the RS for pathloss calculation associated with the one configured UL or joint TCI state are associated with a same physical cell identity (PCID).

7. The UE of claim 1, wherein all activated UL or joint TCI states associated with a same CORESETPoolIndex value are associated with a same physical cell identity (PCID).

8. A method performed by a user equipment (UE), the method comprising:
receiving a medium access control (MAC) control element (MAC CE) including a control resource set (CORESET) pool ID field to activate one or multiple uplink (UL) or joint transmission configuration indication (TCI) states among configured UL or joint TCI states; and
receiving a downlink control information (DCI) indicating one UL or joint TCI state when multiple UL or joint TCI states are activated.

9. A base unit for wireless communication, comprising:
at least one memory; and
at least one processor coupled with the at least one memory and configured to cause the base unit to:
transmit a medium access control (MAC) control element (MAC CE) including a control resource set (CORESET) pool ID field to activate one or multiple uplink (UL) or joint transmission configuration indication (TCI) states among configured UL or joint TCI states; and
transmit a downlink control information (DCI) indicating one UL or joint TCI state when multiple UL or joint TCI states are activated.

10. The base unit of claim 9, wherein when one UL or joint TCI state is activated by the MAC CE, the one UL or joint TCI state is associated with a CORESETPoolIndex indicated by the CORESET pool ID field included in the MAC CE.

11. The base unit of claim 9, wherein when multiple UL or joint TCI states are activated by the MAC CE, the activated multiple UL or joint TCI states are mapped to one or more TCI codepoints indicated by DCI format 1_1 or 1_2 carried by physical downlink control channel (PDCCH) received from any one or more CORESETs configured with a CORESETPoolIndex value that is a same value as that indicated by the CORESET pool ID field included in the MAC CE.

12. (canceled)

13. The base unit of claim 9, wherein, the at least one processor is further configured to cause the base unit to determine that the activated or indicated TCI state is applied to one or more of:
physical uplink shared channel (PUSCH) transmission scheduled by DCI carried by physical downlink control channel (PDCCH) received from any CORESET associated with a same CORESETPoolIndex associated with the activated or indicated TCI state;
type 2 configured grant (CG) PUSCH transmission activated by DCI carried by PDCCH received from any CORESET associated with the same CORESETPoolIndex associated with the activated or indicated TCI state; or
type 1 CG PUSCH transmission corresponding to a ConfiguredGrantConfig associated with the same CORESETPoolIndex associated with the activated or indicated TCI state.

14. The base unit of claim 9, wherein when the configured UL or joint TCI states are associated with different physical cell identities (PCIDs), a reference signal (RS) for transmitter (TX) spatial filter determination in one of the configured UL or joint TCI states and the RS for pathloss calculation associated with the one configured UL or joint TCI state are associated with a same physical cell identity (PCID).

15. (canceled)

16. A processor for wireless communication, comprising:
at least one controller coupled with at least one memory and configured to cause the processor to:
receive a medium access control (MAC) control element (MAC CE) including a control resource set (CORESET) pool ID field to activate one or multiple uplink (UL) or joint transmission configuration indication (TCI) states among configured UL or joint TCI states; and
receive a downlink control information (DCI) indicating one UL or joint TCI state when multiple UL or joint TCI states are activated.

17. The processor of claim 16, wherein when one UL or joint TCI state is activated by the MAC CE, the one UL or joint TCI state is associated with a CORESETPoolIndex indicated by the CORESET pool ID field included in the MAC CE.

18. The processor of claim 16, wherein when multiple UL or joint TCI states are activated by the MAC CE, the activated multiple UL or joint TCI states are mapped to one or more TCI codepoints indicated by DCI format 1_1 or 1_2 carried by physical downlink control channel (PDCCH) received from any one or more CORESETs configured with a CORESETPoolIndex value that is a same value as that indicated by the CORESET pool ID field included in the MAC CE.

19. The processor of claim 18, wherein one of the activated multiple UL or joint TCI states is indicated by the DCI format 1_1 or 1_2 carried by PDCCH received from any CORESET configured with CORESETPoolIndex having a same value as that indicated by the CORESET pool ID field, and is associated with a same CORESETPoolIndex value configured for the CORESET.

20. The processor of claim 16, wherein the at least one controller is further configured to cause the processor to apply the activated or indicated TCI state to one or more of:
physical uplink shared channel (PUSCH) transmission scheduled by DCI carried by physical downlink control channel (PDCCH) received from any CORESET associated with a same CORESETPoolIndex associated with the activated or indicated TCI state;
type 2 configured grant (CG) PUSCH transmission activated by DCI carried by PDCCH received from any CORESET associated with the same CORESETPoolIndex associated with the activated or indicated TCI state; or
type 1 CG PUSCH transmission corresponding to a ConfiguredGrantConfig associated with the same CORESETPoolIndex associated with the activated or indicated TCI state.

21. The processor of claim 16, wherein when the configured UL or joint TCI states are associated with different physical cell identities (PCIDs), a reference signal (RS) for transmitter (TX) spatial filter determination in one of the configured UL or joint TCI states and the RS for pathloss calculation associated with the one configured UL or joint TCI state are associated with a same physical cell identity (PCID).

22. The processor of claim 16, wherein all activated UL or joint TCI states associated with a same CORESETPoolIndex value are associated with a same physical cell identity (PCID).
